(19) United States
(12) Patent Application Publication
(10) Pub. No.: US 2005/0122096 A1
(43) Pub. Date: Jun. 9, 2005

(54) Detector for sensing the rotational movement of an electric motor in stand-by mode

(76) Inventor: Dong-lei Wang, Zhuhai City (CN)

Correspondence Address: CARSTENS YEE & CAHOON, LLP, P O BOX 802334, DALLAS, TX, 75380, US

(21) Appl. No.: 10/948,022

(22) Filed: Sep. 23, 2004

(30) Foreign Application Priority Data
Dec. 9, 2003 (CN) 200310112482.1
Dec. 9, 2003 (CN) 200320118957.3

(51) Int. Cl. G01B 7/14

(52) U.S. Cl. 324/207.2

(57) ABSTRACT

The present invention disclosed a detector for sensing the rotational movement of an electric motor in stand-by mode, comprising a control circuit, a thyristor, and a power supply circuit; wherein, one output terminal of said control circuit is connected to the gate of said thyristor, and wherein said power supply circuit, electric motor and thyristor are connected in series; wherein said detector further includes a sensing circuit and an indicator light, said sensing circuit for detecting whether the loop of said power supply circuit, electric motor and thyristor are conducting; wherein one output terminal of said sensing circuit is connected to said control circuit for providing a feed-back signal to said control circuit; wherein said control circuit has an output terminal connected to said indicator light so as to control an on/off state of the indicator light.

### TECHNICAL FIELD

This invention relates to motor-driven household appliances, especially to a detector for sensing the rotational movement of its electric motor in stand-by mode.

### BACKGROUND OF THE INVENTION

In the existing motor-driven household appliances, no detector is provided to indicate whether they are normal in stand-by mode (when the power is on but the machines are not initiated yet). Therefore, if abnormality occurs, users will likely be hurt when the machines are initiated, especially for those with blade or blade disc.

### SUMMARY OF THE INVENTION

The main object of the present invention is to overcome the shortcomings of the prior art and to provide a detector to sense the rotational movement of an electric motor in stand-by mode.

The detector according to the present invention comprising:
a control circuit,
a thyristor,
and a power supply circuit;
wherein, one output terminal of said control circuit is connected to the gate of said thyristor, and wherein said power supply circuit, electric motor and thyristor are connected in series; wherein said detector further includes a sensing circuit and an indicator light, said sensing circuit for detecting whether the loop of said power supply circuit, electric motor and thyristor are conducting; wherein one output terminal of said sensing circuit is connected to said control circuit for providing a feed-back signal to said control circuit; wherein said control circuit has an output terminal connected to said indicator light so as to control an on/off state of the indicator light.

Said power supply circuit may be an alternating power source, and said thyristor may be a triac.

Said sensing circuit may include a Hall sensor, which is suitably positioned to sense the rotational movement of said electric motor.

Said sensing circuit may include a photodiode. If the thyristor is a triac, the sensing terminals of said sensing circuit may be connected respectively with T1 terminal and T2 terminal of said triac. If the thyristor is a scr, the sensing terminals of said sensing circuit may be connected respectively with the anode and cathode of said scr.

Said sensing circuit may include a mutual inductance, the primary circuit of said inductance is connected between said triac and electric motor, the secondary circuit of said inductance is for providing feed-back signals to said control circuit.

The working principle of said detector is as follows:

In normal stand-by mode, the loop of said power supply circuit, electric motor and thyristor is non-conducting. If no rotational movement of the electric motor is detected or if the thyristor is detected to be non-conducting, it means that the machine is in normal status, then the indicator light flashes under the control of the control circuit, so as to indicate permit of further operations to the machine. If rotational movement of the electric motor is detected or if the thyristor is detected to be conducting, it means that the machine is in abnormal status, then the indicator light is off under the control of the control circuit, so as to indicate abnormality and prohibition of any further operations to the machine.

### BRIEF DESCRIPTION OF THE DRAWINGS

FIG. 1 is the schematic circuit block diagram of the first embodiment of the present invention, wherein, the sensing circuit using a Hall sensor;

FIG. 2 is the schematic circuit block diagram of the second embodiment of the present invention, wherein, the sensing circuit is connected across the thyristor;

FIG. 3 is the schematic circuit block diagram of the third embodiment of the present invention, wherein, the sensing circuit is connected across the electric motor;

FIG. 4 is the schematic circuit block diagram of the fourth embodiment of the present invention;

FIG. 5 is the circuit connect diagram of the detector shown in FIG. 1;

FIG. 6 is the circuit connect diagram of the detector shown in FIG. 2;

FIG. 7 is the circuit connect diagram of the detector shown in FIG. 3;

FIG. 8 is the circuit connect diagram of the detector shown in FIG. 4;

FIG. 9 is a circuit connect diagram showing an alternative circuit of the indicator light according to the present invention;

FIG. 10 is a circuit connect diagram showing an alternative circuit of the control circuit according to the present invention.

### DETAILED DESCRIPTION OF THE PREFERRED EMBODIMENTS

### Embodiment 1

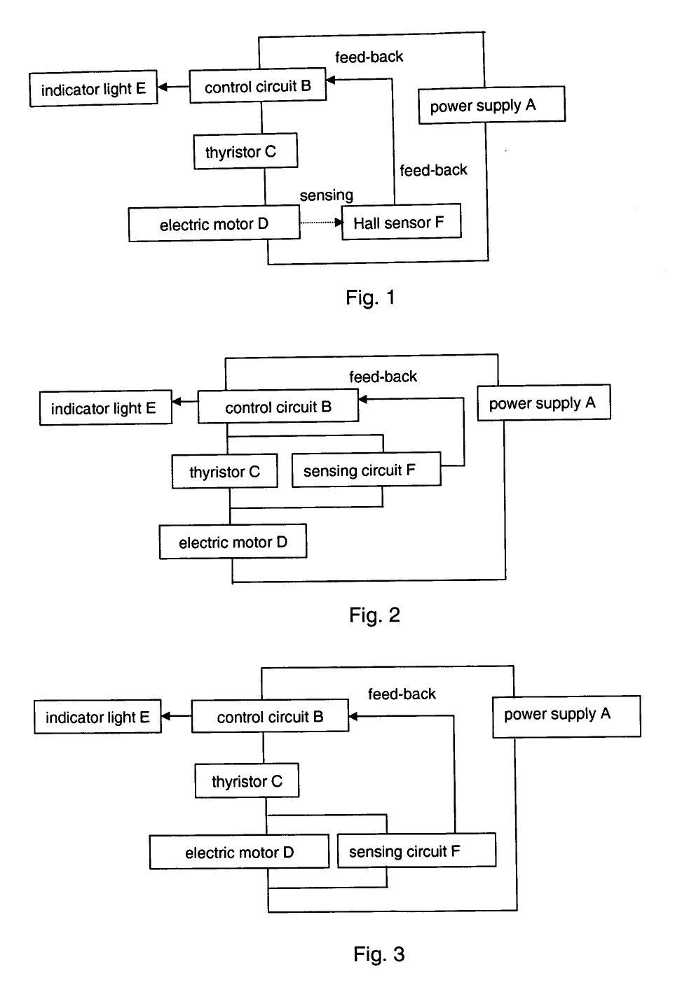

As shown in FIG. 1, in the first embodiment, the detector comprises a control circuit B, a thyristor C, an electric motor D, a power supply circuit A, a sensing circuit F and an indicator light E.

The sensing circuit F may use a Hall sensor, which is suitably positioned to detect the rotational movement of the electric motor D.

One output terminal of the sensing circuit F is connected to the control circuit B and sends feed-back signals to the control circuit B. The control circuit B has an output terminal connected to the indicator light E so as to control the on/off of the indicator light E.

As shown in FIG. 5, the power supply circuit A is supplying an alternating current, the thyristor C is a triac, and the indicator light E is a red LED light. If the motor D is not rotating, the magnetic field of the motor D will not change, then, the sensing circuit F will not be initiated, and the leg 3 of the sensing circuit F will keep sending a high level voltage signal to the control circuit B. After judgement, the control circuit B sends a voltage signal, the level of which is alternating in a certain pattern, to the LED light E. When the voltage signal sent from the control circuit B is at high level, the LED light E is on, while when the voltage signal sent from the control circuit B is at low level, the LED light E is off, so that, the LED light flashes. If the motor D is rotating, the sensing circuit F will be initiated by the changing magnetic field of the motor D, then, the leg 2 and leg 1 of the sensing circuit F will be conducting, and the leg 3 of the sensing circuit F will input a low level voltage signal to the control circuit B. After judgement, the control circuit B sends a low level voltage signal to the LED light E and the LED light E is off.

### Embodiment 2

As shown in FIG. 2, the difference from embodiment 1 is that, the sensing circuit F is using a photodiode, the two terminals of the sensing circuit F is connected respectively with the terminal T1 and terminal T2 of the triac C. If the terminals T1 and T2 are conducting, no current flow is in the sensing circuit F, the sensing circuit F then sends feed-back signals to the control circuit B, the red indicator light E will be off under the control of the control circuit B. If the terminals T1 and T2 are non-conducting, there is current flow in the sensing circuit F, the sensing circuit F then sends feed-back signals to the control circuit B, the red indicator light E will flash under the control of the control circuit B.

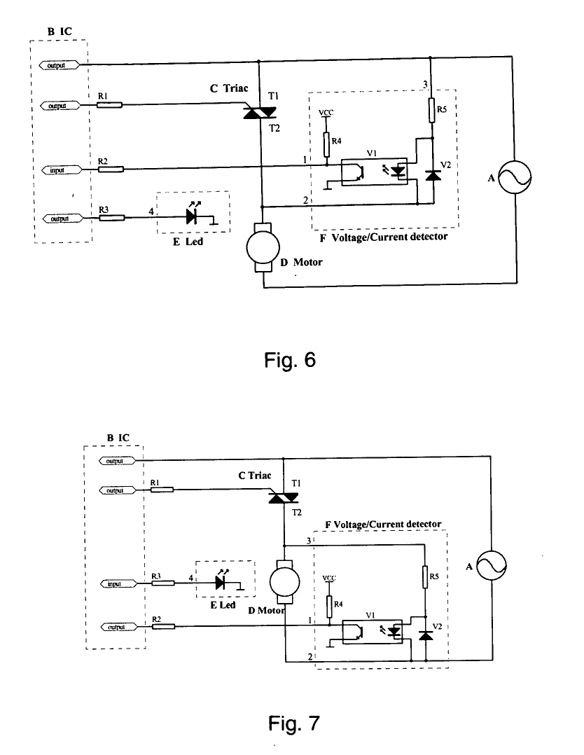

As shown in FIG. 6, If the terminals T1 and T2 of the triac are conducting, there is no current flow between the leg 3 and leg 2 of the sensing circuit F, and the photodiode will be non-conducting, the leg 1 of the sensing circuit F keeps sending a high level voltage to the control circuit B. After judgement, the control circuit B sends a low level voltage signal to the LED light E and the LED light E is off. If the terminals T1 and T2 of the triac are non-conducting, there is current flow between the leg 3 and leg 2 of the sensing circuit F, and the photodiode will be conducting, the leg 3 of the sensing circuit F will input a low level voltage signal to the control circuit B. After judgement, the control circuit B sends a voltage signal, the level of which is alternating in a certain pattern, to the LED light E to make it flash.

### Embodiment 3

As shown in FIG. 3, the difference from embodiment 1 is that, the sensing circuit F is using a photodiode, the two sensing points are connected respectively with the two terminals of the motor D. If there is current flow in the loops of the motor, there will be current flow in the sensing circuit F, the sensing circuit F then sends feed-back signals to the control circuit B, the red indicator light E will be off under the control of the control circuit B. If there is no current flow in the loops of the motor, there will be no current flow in the sensing circuit F, the sensing circuit F then sends feed-back signals to the control circuit B, the red indicator light E will flash under the control of the control circuit B.

As shown in FIG. 7, If there is current flow in the loops of the motor, there will be current flow between the leg 3 and leg 2 of the sensing circuit F, and the photodiode will be conducting, the leg 3 of the sensing circuit F will input a low level voltage signal to the control circuit B. After judgement, the control circuit B sends a low level voltage signal to the LED light E and the LED light E is off. If there is no current flow in the loops of the motor, there will be no current flow between the leg 3 and leg 2 of the sensing circuit F, and the photodiode will be non-conducting. The leg 1 of the sensing circuit F keeps sending a high level voltage to the control circuit B. After judgement, the control circuit B sends a voltage signal, the level of which is alternating in a certain pattern, to the LED light E to make it flash.

For either of embodiments 2 and 3:

The sensing circuit F may be in an alternative circuit as shown in FIG. 10, wherein one diode is replaced by four diodes.

The photodiode may be chosen from 817 series or other series. The diodes may be chosen from series 1N4001-4007.

### Embodiment 4

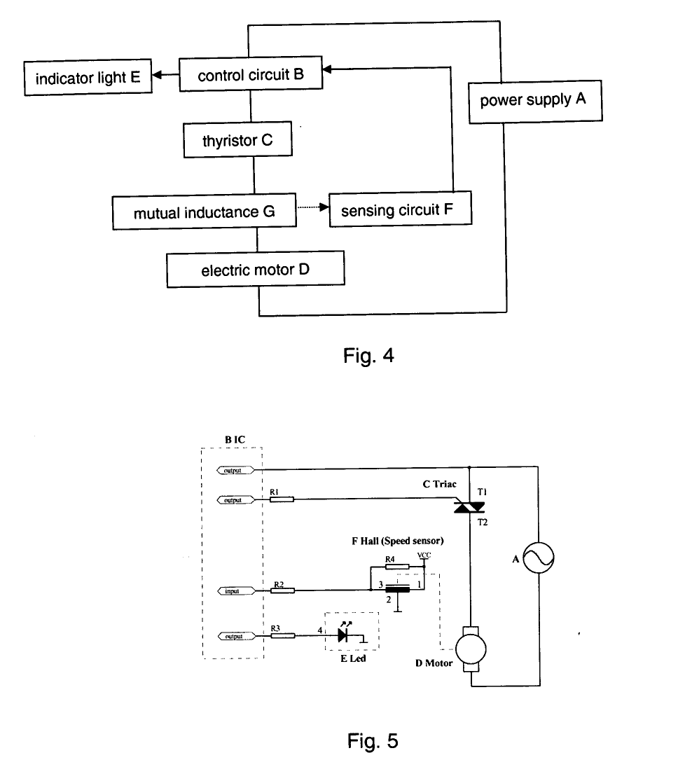

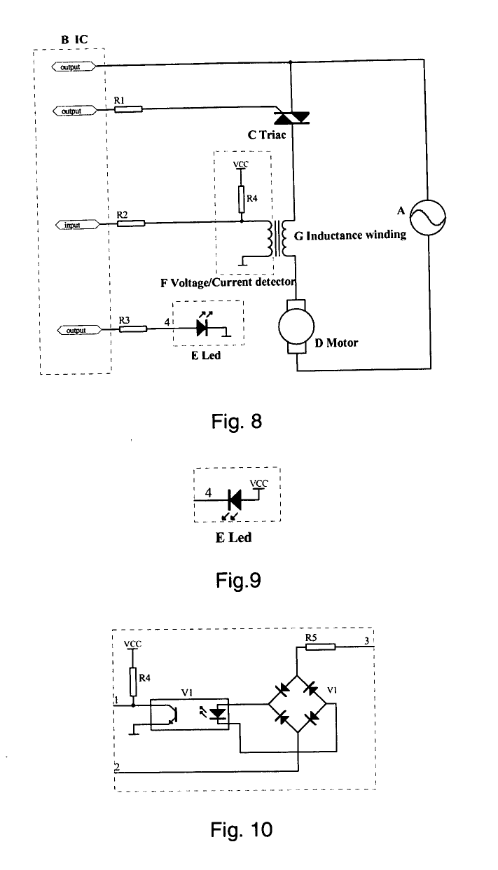

As shown in FIG. 4 and FIG. 8, the difference from embodiment 1 is that, the sensing circuit F is using a mutual inductance G, the primary circuit of the inductance G is connected between the triac C and the electric motor D, the secondary circuit of the inductance G sends feed-back signals to the control circuit B. If there is current flow in the primary circuit of the inductance G, then there will be current flow as well as voltage in the secondary circuit of the inductance G, the sensing circuit F then inputs a low level voltage signal to the control circuit B. After judgement, the control circuit B sends a low level voltage signal to the LED light E and the LED light E is off. If there is no current flow in the in the primary circuit of the inductance G, then there will be no current flow in the in the secondary circuit of the inductance G, the sensing circuit F keeps sending a high level voltage to the control circuit B. After judgement, the control circuit B sends a voltage signal, the level of which is alternating in a certain pattern, to the LED light E to make it flash.

For any of embodiments 1, 2, 3 and 4:

The light E may be connected with the control circuit B in an alternative way as shown in FIG. 9. When the control circuit B sends out a low level voltage, the light E is on, while when the control circuit B sends out a high level voltage, the light E is off.

1-5. (canceled)

6. An optical code decoding system comprising:
an imaging apparatus for obtaining and displaying video image signals comprising:
an optical code reader including:
a two dimensional image sensor for sensing light incident on the image sensor and generating image data corresponding to the sensing when operating in an optical code reading mode, the image data including data corresponding to at least a portion of a captured optical code, and video data corresponding to the sensing when operating in a video data communication mode, the video data output at at least three frames per second;
means for compressing said video data;
a host terminal with a communication port and display;
a narrow band width data link over which compressed video data from the optical code reader are communicated to the communication port of the host terminal; and
at least one processor for decoding the optical code captured at least partially by at least the image data.

7. The system of claim 6, wherein the imaging apparatus further comprises means for detecting and processing a command bar code for switching the optical code reader between the optical code reading mode and the video data communication mode.

8. The system of claim 6, wherein the optical code reader includes a microprocessor and output driver for communication with the host terminal, and wherein the communication port of the host terminal is a serial communication port for receiving the compressed video data and for receiving decoded information corresponding to optical codes read by the optical code reader.

9. The system of claim 6, wherein the narrow band width data link is a cable connected between the optical code reader and the communication port of the host terminal.

10. The system of claim 6, wherein the narrow band width data link is a radio frequency transmitter and receiver.

11. The system of claim 6, wherein the narrow band width data link is an infrared transmitter and receiver.

12. The system of claim 6, wherein the imaging apparatus further comprises means for detecting motion in a field of view of the optical code reader.

13. The system of claim 12, wherein motion is detected by monitoring the bandwidth of the compressed video signal.

14. A method for reading an optical code disposed on an object and obtaining at least one physical parameter of said object, comprising the steps of:
providing an optical code reader configured for acquiring image data including data corresponding to at least a portion of a target optical code and video data, and outputting the video data at at least three frames per second; and
performing motion detection using the optical code reader comprising the steps of:
positioning an image sensor of the optical code reader so that a field of view of the image sensor includes a region to be monitored for motion;
switching the optical code reader from an optical code reading mode for processing the image data to a video mode for processing the video data;
analyzing video data corresponding to the field of view of the image sensor comprising:
identifying changes between sets of frames of the video data corresponding to the field of view; and
monitoring the frequency of the changes between the sets of frames of the video data corresponding to the field of view to identify frequency changes indicative of the movement of objects of interest in the field of view.

15. The method of claim 14, further comprising the steps of:
compressing the video data corresponding to the field of view;
transmitting the compressed video data from the optical code reader to a terminal; and
displaying an image corresponding to the field of view of the image sensor at the terminal based on detection of motion in the field of view in accordance with the identification of frequency changes.

16-30. (canceled)

31. The method of claim 14, further comprising the steps of:
measuring orthogonal dimensions of a rectangular solid object in the field of view of the image sensor, comprising the steps of:
obtaining pixel information for the field of view of the image sensor;
determining a distance between the object and the image sensor;
determining the angles between edges of the rectangular solid meeting at a nearest corner of the object and determining an imaged length of edges of the rectangular solid to be measured from the pixel information; and
scaling the determined image length of the edges responsive to the determined angles and determined distance between the rectangular solid and the image sensor to obtain an approximation of the actual length of said edges.

32. The method of claim 31, wherein the distance between the object and the image sensor is determined from a detected image of an aiming pattern projected onto the object.

33. The method of claim 31, wherein the distance between the object and the image sensor is determined from at least one image dimension of an optical code symbol of known size on the object.

34-35. (canceled)

36. The system of claim 6, wherein the at least one processor further measures a physical parameter of an object from at least one of the image data and the video data.

37. The system of claim 6, wherein the imaging apparatus is used to perform optical code reading and to perform area surveillance.

38. An imaging device for reading optical codes and providing video image signals comprising:
an image sensor having a field of view;
a manually actuated trigger switch for initiation of reading an optical code in the field of view of the image sensor;
output circuitry for selectively outputting one of video data generated by the image sensor at at least three image frames per second corresponding to a dynamic two dimensional image in the field of view of the image sensor; and data corresponding to the reading of the optical code.

39. The imaging device of claim 38, further comprising:
means for monitoring the frequency of changes between frames of video data to identify frequency changes indicative of the movement of objects of interest in the field of view.

40. The imaging device of claim 38, further comprising a display at a remote terminal for monitoring and displaying an image corresponding to the field of view of the image sensor.
